(19) United States
(12) Patent Application Publication
(10) Pub. No.: US 2006/0058134 A1
(43) Pub. Date: Mar. 16, 2006

(54) Gearshift control apparatus for a bicycle and a bicycle equipped with such apparatus

(75) Inventors: Jean-Pierre Mercat, Chavanod (FR); Franck Dumontier, Annecy (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 11/203,987

(22) Filed: Aug. 16, 2005

Related U.S. Application Data
(63) Continuation of application No. PCT/FR04/00359, filed on Feb. 17, 2004.

(30) Foreign Application Priority Data
Feb. 17, 2003 (FR) 03.02049

(51) Int. Cl. F16H 59/00; F16H 63/00

(52) U.S. Cl. 474/80

(57) ABSTRACT

An apparatus for controlling a bicycle transmission system with variable ratio, having at least one gearshift device, two control actuating devices, and a relay device for guiding the gearshift device(s) from the control actuating devices, and a bicycle equipped with such apparatus. Each control actuating device has an actuation member located within the reach of each of the cyclist's hands, and it is provided to transmit only one type of control, one of the actuating devices being capable of transmitting an upshift control and the other a downshift control of the transmission ratio.

### CROSS-REFERENCE TO RELATED APPLICATIONS

This application is a continuation of international patent application No. PCT/FR2004/000359, filed Feb. 17, 2004, the disclosure of which is hereby incorporated by reference thereto in its entirety and the priority of which is hereby claimed under 35 USC §120.

This application is also related to French patent application No. 03 02049, filed Feb. 17, 2003, the disclosure of which is hereby incorporated thereto in its entirety and the priority of which is hereby claimed under 35 USC §119.

### BACKGROUND OF THE INVENTION

1. Field of the Invention

The invention relates to a gearshift control apparatus for a bicycle, as well as to a bicycle equipped with such an apparatus.

2. Description of Background and Relevant Information

Gearshift devices for bicycles usually include a sprocket, or chainwheel, assembly and a derailleur for switching the chain from one sprocket to the next, or from one chainwheel to the next. Mechanically controlled derailleurs are the most widely used, but electrically or pneumatically controlled derailleurs are also used. Such derailleurs are disclosed, for example, in U.S. Pat. No. 5,358,451 and in the patent documents EP 558 425 and EP 826 591.

Also known are gearshift devices that include a single sprocket or chainwheel having a variable diameter, or which are positioned at the entry or exit of a gearbox with variable ratio. Such modes of construction are described, for example, in the patent document EP 1 145 947.

The transmission member in these systems is a chain, but there are constructions that use other transmission members, such as fluid or a rotationally driven shaft, for example.

For systems that have two gearshift devices, namely a front device and a rear device, two separate control devices are generally used. Each of the control devices guides a gearshift device in the two directions of the transmission ratio, that is, upshift and downshift. To shift gears in these conditions, the cyclist has to select one of four possible maneuvers of the controls.

Furthermore, it is difficult for the user to concentrate on the operation to be carried out, as he/she is often disturbed by fatigue, rough road conditions, concentration on riding, and road safety, for example.

Control devices also exist which manage the gearshifts of the two derailleurs from a single control. Such a device is described, for example, in the international patent Publication WO 96/25321. The control is provided from a rotatable handle that guides the synchronization of the displacement of the two derailleurs by means of cam grooves.

Such a device yields good results but, here again, the control device can perform two different controls that have opposite effects on the transmission ratio.

Indeed, the user controls the gear upshift and downshift by maneuvering the same control member using the same hand or the same fingers of one hand to which he/she must impart a different movement.

### SUMMARY OF THE INVENTION

An object of the invention is to propose a functionally improved control device, in which the gearshift controls are completely differentiated and have better ergonomics.

To this end, the invention is directed to an apparatus for controlling a bicycle transmission system with variable ratio, the transmission system including at least one gearshift device that is capable of shifting the transmission ratio in two directions, referred to as upshift and downshift, from a control that is transmitted thereto from the control device, a relay device located between the control device and the gearshift device(s) for guiding the gearshift device(s) in response to the controls transmitted by the control device, the control device being capable of transmitting two types of controls of the gear ratio to the relay device, namely an upshift control and a downshift control.

The apparatus includes two distinct actuating devices, each actuating device having a movable actuation member provided to be actuated by a user, an actuation member being provided to be positioned within the reach of each of the user's hands, and in that one of the actuating devices sends a single upshift control of the transmission ratio, while the other actuating device sends a single downshift control of the transmission ratio to the relay box.

The bicycle includes a frame, a handlebar having two handlebar grips provided for each of the user's hands, a variable ratio transmission system, and a control apparatus.

The control apparatus includes two distinct control actuating devices, each having a movable actuation member, an actuation member being mounted in the immediate proximity of each handlebar grip, whereby one of the control actuating devices sends a single upshift control and the other control actuating device sends a single downshift control.

In this way, the user controls the upshift and downshift of the transmission ratio by maneuvering distinct control members by means of different elements, i.e., he/she actuates the upshift member using one hand, and the downshift member using the other hand. Automatic control is therefore easier to implement.

### BRIEF DESCRIPTION OF DRAWINGS

The invention will be better understood from the following description, with reference to the attached drawings, in which:

FIG. 1 is a schematic view of a bicycle transmission assembly according to a first embodiment of the invention, showing the bicycle in partial cut-away;

FIG. 2 is a schematic cut-away view of a front portion of the bicycle, showing a relay box according to the embodiment of FIG. 1;

FIG. 3 schematically shows the control devices and the relay box according to the invention of FIGS. 1 and 2;

FIGS. 4 and 5 are two views of a unidirectional driving device of the relay box according to the invention of FIGS. 1-3, in its two functional configurations;

FIG. 6 shows the indexing mechanism of the relay box according to the invention of FIGS. 1-5;

FIGS. 7-9 show respective alternative embodiments of the invention.

### DETAILED DESCRIPTION OF THE INVENTION

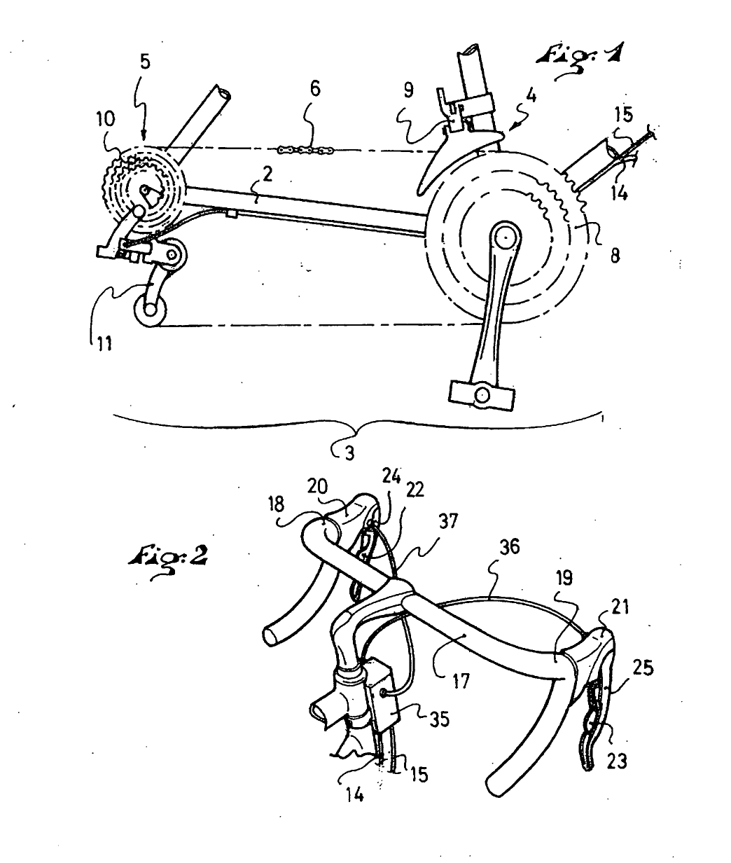

FIG. 1 shows a portion of the rear portion of a bicycle frame 2 that carries a transmission assembly 3.

The transmission assembly includes a front subassembly 4 driven by the crankset, a rear sub-assembly 5 for driving the rear wheel, and a transmission chain 6 connecting the two sub-assemblies.

The front subassembly 4 is formed of a cluster of chainwheels 8 and a front derailleur 9 mounted on the frame.

At the rear, there is a sprocket cassette 10, as well as a derailleur 11 of a known type.

In the present case, the front and rear derailleurs are mechanical, and are each controlled by a cable 14 and 15, respectively, that runs along the tubes of the frame.

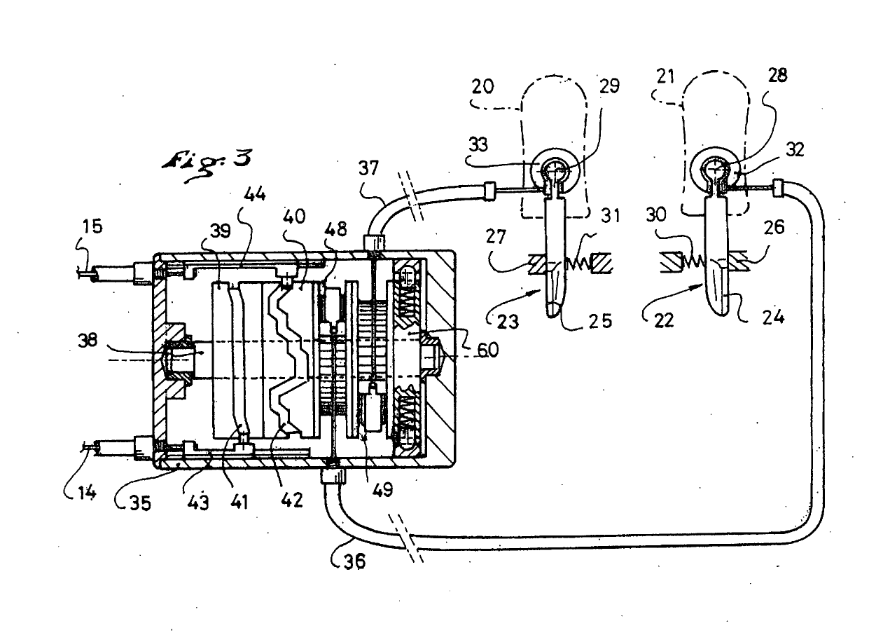

FIG. 2 shows a perspective view of the bicycle handlebar 17. As is conventional, the handlebar has a right handlebar grip 18 and a left handlebar grip 19, provided to be gripped by the user's right and left hands, respectively.

Each of the brake lever supports 20, 21 is mounted on a respective one of the handlebar grips.

According to the embodiment shown, the gearshift control levers 22, 23 are mounted on respective ones of the supports 20, 21, directly behind the brake levers 24, 25.

The mechanical connection between the brake lever and the support is of any appropriate conventional type and has not been described in detail.

For example, a construction disclosed in any of the patent documents EP 504 118, EP 371 254, DE 31 36 922, and EP 399 356 can be used. In these constructions, the gearshift control lever is movable about an axis parallel or perpendicular to the axis of rotation of the braking lever.

Alternatively, other constructions can be used.

Each of the control levers could also be mounted on a support that is independent of the braking lever support, or a pivoting handle, such as disclosed in the patent document FR 2 705 079.

In the case of an all-terrain bicycle, one could similarly have a lever borne by a support mounted on the handlebar bend, or a pivoting handle mounted on the handlebar grip of the bend.

To facilitate the understanding of the invention, the term “actuating device” will be used to designate any gearshift control device, whether it is of the rotatable handle, rocking lever, or other type.

FIG. 3 schematically shows the two gearshift actuating devices 22 and 23.

Each of the actuating devices has an actuation member 24, 25, respectively, that is within the reach of each of the user's hands, or fingers of the hands, and by means of which the actuating device is displaced from a resting position defined, for example, by an abutment designated schematically by the reference numerals 26, 27.

From this resting position, the actuating devices can be displaced about a displacement axis 28, 29 in a single direction, against the return force of a return member, such as a spring 30, 31, for example. The abutments and the return members are of any appropriate conventional types and can be housed in the support of the actuating devices.

The actuating devices can be displaced symmetrically in order to take advantage of a symmetrical movement of the two hands. For example, as shown, each actuating device can be displaced in the direction of the other toward the median plane of the handlebar.

Thus, each of the actuating devices is actuated by a single had of the user, and it can only be displaced in a single direction from its resting position.

The two actuating devices are connected by cable systems 36 and 37 to a relay box that is schematically designated by the reference numeral 35.

For example, as known, each of the actuating devices includes a pulley 32, 33 for winding a cable, or any other appropriate device capable of causing the displacement of a cable with each of its movements. The cable is preferably arranged such that it is itself kept tensioned by an elastic return member, so that the cable moves on its own when the movement of the actuating device would tend to push it back.

As a possible construction, a single return member could be provided for both the cable and the actuating device, such return member being located downstream of the cable in order to return these two elements to the resting position.

The function of the relay box 35 is to transform the controls coming from each of the actuating devices 22 and 23 into a synchronized upshift and/or downshift control of each of the derailleurs, so that the actuating devices can only act in a single direction on the variation of the transmission ratio of the derailleurs.

In other words, the relay box 35 guides the two derailleurs such that each of the two actuating devices only controls the upshift or the downshift of the overall transmission ratio. For example, the lever 23 located within the reach of the right hand controls the upshift of the transmission ratio, and the lever 22 the downshift.

In this way, each hand only has one possible control movement and, by means of this movement, it can only act in a single direction of variation in the transmission ratio.

Therefore, one has a simplified control device with improved ergonomics, in that it enables a more automatic movement for shifting gears.

Indeed, the user controls the upshift of the transmission ratio with the movement of one hand, and the downshift with the movement of the other hand; and the movements are preferably symmetrical. Automatic control is therefore simplified.

According to the embodiment of FIG. 3, the relay box 35 is of the mechanical type.

More particularly, the relay box 35 includes a main shaft 38, the median portion of which has flat portions or any other appropriate device, such as a cotter, in order to drive a plurality of juxtaposed elements in the same rotational movement.

Two drums 39 and 40 are mounted on the shaft 38. The drums have a cam groove 41, 42 in their peripheries, in which are engaged the pins of the driven carriages 43, 44 that are translationally guided along parallel sides of the shaft 38. The cables 14 and 15 for controlling the front and rear derailleurs are connected to each of the carriages 43 and 44. The rotation forces the driven carriages to move along the cam grooves, thereby causing the displacement of the front and rear derailleurs which force the chain to change the sprocket or the chainwheel.

The rotation of the drums is controlled incrementally, as described below.

The cam grooves are rotationally indexed with respect to one another, and they are multi-staged with a plurality of bearings corresponding to the number of chainwheels and sprockets, respectively, and connection zones between the bearings.

At each rotational increment, the two driven carriages 43, 44 are on bearings of the cam grooves. Each of the increments corresponds to a stable position of the chain on a predetermined sprocket and chainwheel that define the transmission ratio of the transmission assembly.

The passage from one increment to the next guides the displacement of one or both of the two derailleurs in order to shift the chain at the rear and/or at the front, so that the overall transmission ratio increases or decreases progressively. For a traditional sprocket and chainwheel system, the rear derailleur is controlled with each change in the ratio. Sometimes, the front derailleur and rear derailleur are simultaneously controlled by downshifting the rear by one or two sprockets, so as to compensate for the substantial variation in ratio that is induced by the front sub-assembly. The cam grooves are illustrated for this known functioning mode.

The drums are rotationally driven in both directions by two unidirectional driving devices 48, 49 that are mounted in opposite directions and are each connected to only one of the actuating devices 22 and 23 by one of the cables 36, 37.

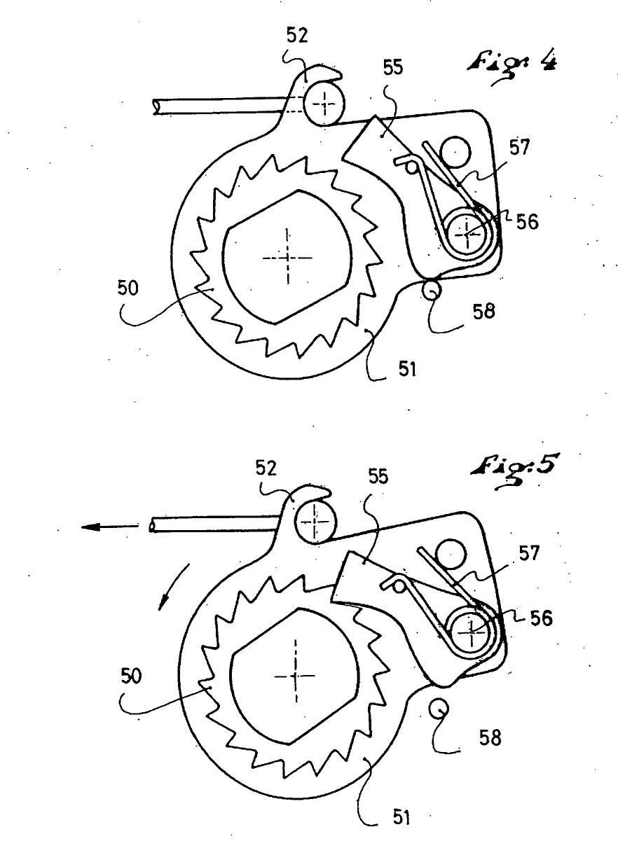

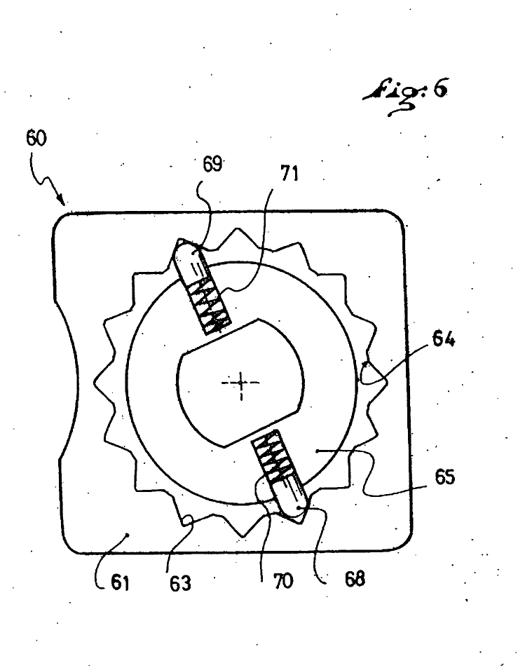

A construction of such a unidirectional mechanism is shown in FIGS. 4 and 5 by way of example.

The mechanism includes a ratchet wheel 50 rotationally affixed to the shaft 38. A stirrup 51 is mounted to rotate freely on the shaft 38. The stirrup carries a fork 52 to which the end of a cable 36 or 37, connected to an actuating device, is hooked. It also carries a pawl 55 for driving the ratchet wheel. The pawl 55 is movable about a pivot 58 mounted on the stirrup 51, and it is returned to the engagement position on the ratchet wheel by a spring 57.

In the resting position shown in FIG. 4, a spring, not shown in the drawing figure, returns the stirrup 51 to abut against an abutment 58. The abutment determines the resting position of the stirrup; it also forces the pawl 55 to a disengaging position with respect to the teeth of the ratchet wheel 50.

During traction exerted on the control cable by means of the control actuating device, the pawl 55 leaves its support on the abutment 58 and engages with the ratchet wheel 50. This is shown in FIG. 5. The stirrup 51 and the ratchet wheel 50 then become rotationally affixed to one another, and the movement of the actuating device causes the rotation of the drums.

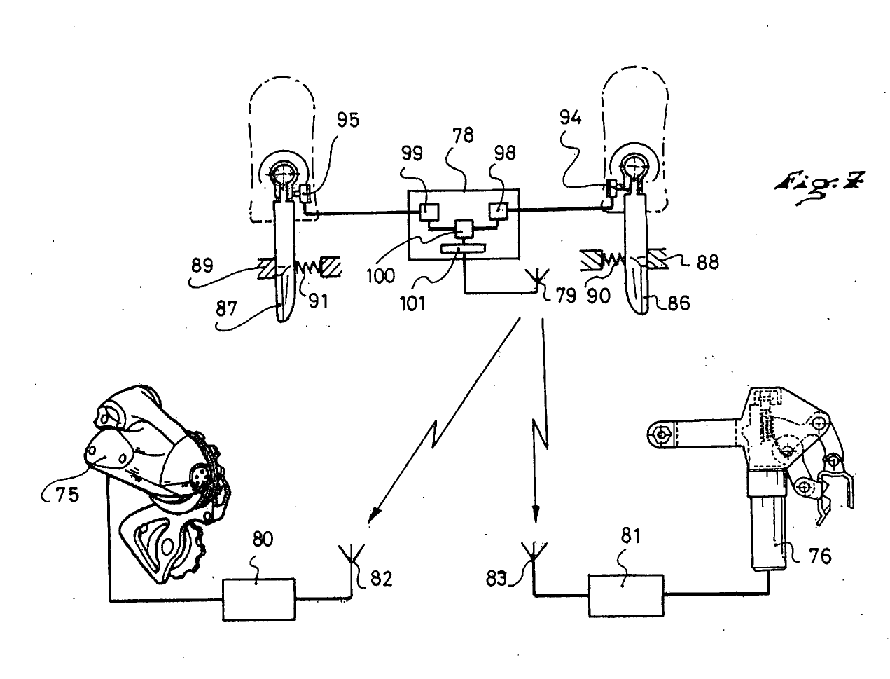

Preferably, an indexing mechanism 60, shown in FIGS. 3 and 6, defines stable positions of the main shaft, which correspond to bearings of the drums.

For example, the indexing mechanism 60 includes a fixed wheel 61 affixedly connected to the box, with a central housing 64 formed with notches 63. A movable wheel 65, rotationally affixed to the shaft 38, is movable in the housing 64; the wheel 65 has two projecting fingers 68 and 69 guided in radial housings of the movable wheel and elastically biased in projection by springs 70, 71. By engaging in the notches 63, the fingers define indexing stable positions of the wheel 65 and of the drums 39 and 40.

The range of movement of the actuating devices 22 and 23 is provided for displacing the drums by at least one indexed increment, and possibly by two or more increments.

Thus, the rely box 35 has two entrances, each being defined by a unidirectional mechanism 48, 49, each of the entrances is connected to a single control actuating device, and each control actuating device is within the reach of a distinct hand of the user.

In this way, the cyclist uses the control within the reach of one hand to control an upshift of the transmission ratio, and the other control located within the reach of the other hand to control a downshift of the transmission ratio.

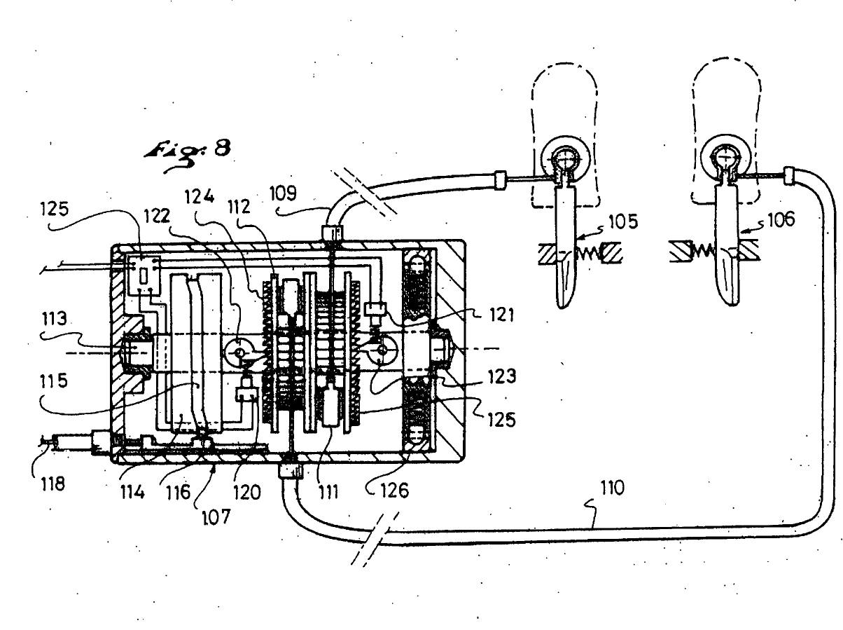

FIG. 7 schematically shows another embodiment of the invention, in which the two derailleurs 75 and 76 are electrically controlled. These derailleurs are of a type known to one having ordinary skill in the art and are not described in detail. The mode of transmission from the controls to the derailleurs is of the wireless type, from a main circuit 78 and an antenna 79 that is located, for example, in the area of the handlebar toward each of the secondary circuits 80 and 81, each being equipped with an antenna 82, 83 and guiding the functioning of a derailleur.

As in the aforementioned embodiment, the control device includes two actuating devices 86, 87, each being located within the reach of a distinct hand of the user.

According to the embodiment shown in FIG. 7, each of the actuating devices is returned by a spring 90, 91 toward a resting position defined by an abutment 88, 89. From the resting position, the actuating device can only be displaced in one direction.

During displacement, each actuating device activates an electric sensor, such as a switch 94, 95, for example, which is itself connected to the main circuit 78.

In an alternative embodiment, one could use a lever that is movable in several directions from a resting position, and which activates a device such as a switch by means of its displacement, regardless of the direction of this displacement.

For each of the switches 94, 95, the circuit 78 has a circuit 98, 99 for processing and shaping the signal. These two circuits are connected to a main processing circuit 100 and a transmitting circuit 101. The processing circuit 78 serves as a relay device; it analyzes the control signals coming from the switches 94 and 95 and synchronizingly guides the two derailleurs 75 and 76, according to a pre-established control strategy that ensures a progressive variation in the transmission ratio by varying a gear shift at the level of one or both of the two derailleurs.

The processing circuit sends control signals to each of the derailleurs by means of the transmitting circuit. For example, as known, coded digital signals are used, which have a first code specific to the system and an auxiliary code for identifying the derailleur that must execute the control.

In this way, the cyclist executes an upshift control of the transmission ratio by acting on an actuating device located within the reach of one hand, and executes a downshift control by means of the other actuating device located within the reach of the other hand. His/her automatic control is therefore simplified.

For this electrically controlled embodiment, the actuating device could be translationally movable, instead of being rockingly mounted, and, in particular, they could be push-buttons activating the switches.

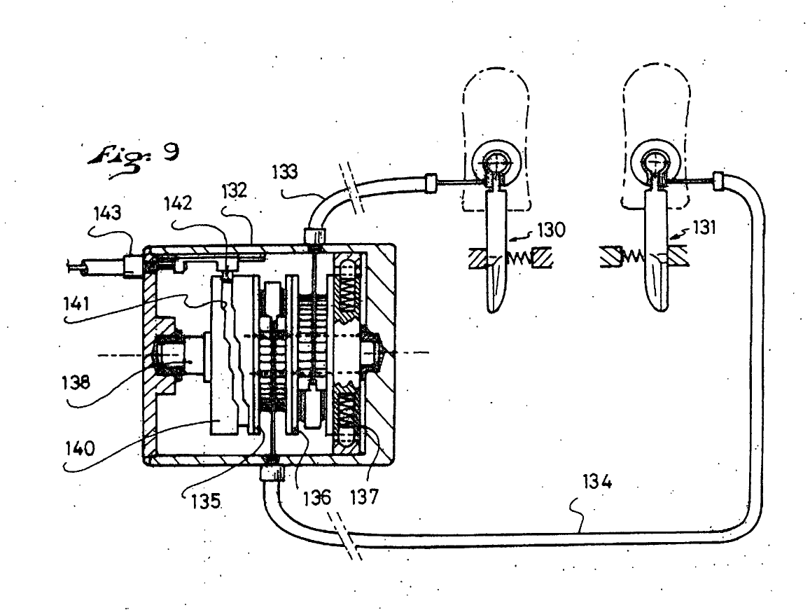

FIG. 8 shows another alternative embodiment of the invention. According to this embodiment, the front derailleur is mechanically controlled and the rear derailleur is electrically controlled.

As for the embodiment of FIG. 3, two control actuating devices 105 and 106 are each connected to a unidirectional driving device 111, 112 mounted on a shaft 113 by means of cables 109, 110. The unidirectional driving devices are housed in a relay box 107.

They rotationally drive a drum 115 that is rotationally affixed to the shaft 113 and provided with a cam groove 115 that guides the displacement of a driven carriage 116. The driven carriage is connected to the front derailleur by a cable 118. This construction is similar to the drum 39 and carriage 43 described in connection with FIG. 3.

Two switches 120 and 121 are provided for the control of the rear derailleur. These switches are each actuated by a ratchet device 122, 123, respectively, which is engaged with an appropriately oriented toothing 124, 125 located on the edge of each of the ratchet wheels of the unidirectional mechanisms.

The orientation of the toothings is such that each ratchet device actuates the switch that is associated therewith for a single direction of rotation of the devices. In the other direction of rotation, the ratchet device has no effect on the switch. The two switches react for opposite directions of rotation of the devices.

In this way, one of the switches is actuated for an upshift control and the other for a downshift control, and transmits an impulse.

A wide range movement of one or the other of the actuating devices can be provided to generate, through successive tooth skips, an impulse section that causes several gearshifts.

As in the preceding cases, an indexing mechanism 126, similar to the mechanism 60, is mounted in the box 107.

The two switches 120 and 121 are connected to a processing circuit 125.

The processing circuit 125 receives differentiated impulses coming from the switches and calculates them.

Another part of the circuit determines, from a table, which position of the rear derailleur corresponds to a new upshift or downshift order. This position depends on the position of the carriage 116 that controls the front derailleur. Indeed, it is known that for a chainwheel switch, it is necessary to displace the rear derailleur in the opposite direction by one or two sprockets to reach the next speed ratio, so as to respect a certain progressiveness.

The circuit 125 can detect the angular position of the drum 114 by calculating the impulses transmitted by the two switches 120 and 121. Another solution involves associating a third switch with the drum 114 and taking into account the impulses transmitted by this switch, or yet using an analog sensor such as a potentiometer, or any other means.

Finally, the processing circuit 125 includes a control circuit that sends a control signal to the rear derailleur so as to move it into the desired position. A wire connection or wireless connection can be used here between the circuit 125 and the derailleur.

This embodiment could also apply in the case of an electrically controlled front derailleur and of a mechanically controlled rear derailleur.

The embodiment of FIG. 9 corresponds to the case where the bicycle is equipped with only one derailleur, such as a front derailleur, for example.

To illustrate this mode of construction, FIG. 9 shows two actuating devices 130 and 131 connected to the relay box 132 by cables 133, 134. The cables are connected to unidirectional mechanisms 135, 136 mounted on a shaft 138 and preferably associated with an indexing mechanism 137.

In this way, each of the actuating devices is capable of driving the rotation of the shaft 138 in a different direction.

A drum 140 is rotationally affixed to the shaft 138. The drum carries on its periphery a cam groove 141 having as many bearings as there are stable positions for the derailleur. A driven carriage 142 engaged with the cam groove moves according to the position imposed thereon by the groove. The carriage is connected to the derailleur by a cable 143.

This embodiment could also apply to the control of an electric derailleur, such as the derailleur 75 described in FIG. 7, for example. Under these conditions, the actuating devices could directly activate the switches.

The present description is only provided by way of example, and other embodiments of the invention could be adopted without leaving the scope thereof.

In particular, the invention could be applied to a mixed system using derailleurs other than mechanically or electrically controlled derailleurs, such as a pneumatically controlled derailleur, for example. Similarly, front and rear derailleurs having different control modes could be used.

The relay device could also be different in the case of a mechanical system. Instead of having two entrances of the same type acting in a similar manner on the rotation of the drums, one of the controls could drive both the rotation of the drums in one direction and the tensioning of a spring for returning the drums, with a retaining device having an escape. The other control acts on the escape system in order to release the rotation of the drums in the opposite direction, under the effect of the return spring.

The control actuating devices could also be integrated with the braking system, i.e., the speed control device and the braking could be controlled with the same lever, along the direction in which this lever is displaced, as known.

The relay box could also be integrated into one or the other of the supports of the actuating devices or of the braking lever, which would make it possible to eliminate one of the two cables 36 or 37.

The present description is only given by way of example, and other embodiments of the invention could be adopted without leaving the scope thereof.

1. An apparatus for controlling a bicycle transmission system with variable ratio, said apparatus comprising:
a transmission system comprising at least one gearshift device for selective changing of a transmission ratio of the transmission system in either of two directions, said two directions consisting of an upshift direction and a downshift direction;
a control device for controlling said at least one gearshift device;
a relay device operably located between the control device and the at least one gearshift device for guiding the at least one gearshift device in response to the control device;
the control device comprising two distinct actuating devices, each of the actuating devices comprising an actuation member adapted to be engaged and moved by a respective one of a user's hands, while the user is mounted upon the bicycle;
the control device being structured and arranged to transmit two types of controls relating to a desired transmission ratio to the relay device, said two types of controls consisting of an upshift control and a downshift control;
a first of the two distinct actuation devices being constructed and arranged to transmit only an upshift control to the relay device;
a second of the two distinct actuation devices being constructed and arranged to transmit only a downshift control to the relay device.

2. An apparatus according to claim 1, wherein:
each of the actuating devices is mounted to move from a resting position in a single direction; and
an elastic return element is positioned to return one or both of the actuating devices to the resting position.

3. An apparatus according to claim 1, wherein:
the relay device has two distinct entrances, each of said two entrances being assigned to a distinct upshift or downshift control; and
each actuating device is connected to only one of the distinct entrances of the relay device.

4. An apparatus according to claim 3, wherein:
the at least one gearshift device comprises two derailleurs;
the relay device includes two drums for guiding respective ones of the two derailleurs, the drums being rotationally affixed to two unidirectional driving devices mounted in opposite directions; and
each unidirectional driving device is connected to an actuating device.

5. An apparatus according to claim 4, wherein:
each of the two drums comprises a cam groove including bearings and transitions zones between the bearings.

6. An apparatus according to claim 4, wherein:
a defined indexing mechanism is rotationally affixed to the unidirectional driving devices.

7. An apparatus according to claim 3, wherein:
the transmission system comprises two derailleurs;
the relay device is electronic and includes two processing and shaping circuits, each circuit being connected to a single control actuating device.

8. An apparatus according to claim 7, wherein:
each circuit is connected to a control actuating device by means of a switch.

9. An apparatus according to claim 3, wherein:
the transmission system comprises two derailleurs;
the relay device includes a drum for guiding a first of the two derailleurs and a processing circuit for guiding a second of the two derailleurs.

10. An apparatus according to claim 9, wherein:
the processing circuit is connected to two actuating devices, each reacting to a different upshift or downshift control.

11. An apparatus according to claim 3, wherein:
the transmission system comprises only a single derailleur;
the relay box includes a drum rotationally affixed to two unidirectional driving devices mounted in opposite directions, each being connected to a control.

12. A bicycle comprising:
a frame;
a handlebar connected to said frame, the handlebar including two handlebar grips;
a transmission system with a variable ratio; and
a control apparatus for controlling the transmission system, the control apparatus comprising:
at least one gearshift device for shifting the transmission ratio in either of two directions, said two directions comprising upshift and downshift, from a control that is transmitted to the at least one gearshift from said control apparatus;
a control device for controlling said at least one gearshift device, said control device comprising two distinct actuating devices, each of the actuating devices comprising an actuation member in the form of a movable gripping member mounted proximate a respective one of the two handlebar grips for engagement and movement by a respective one of a user's two hands, while the user is mounted upon the bicycle;
a relay device operatively located between the control device and the at least one gearshift device for guiding the at least one gearshift device in response to the controls transmitted by the control device;
the control device being capable of transmitting two types of controls to the relay device relating to a desired transmission ratio, said two types of controls consisting of an upshift control and a downshift control;
a first of the two distinct actuation devices being constructed and arranged to transmit only an upshift control to the relay device;
a second of the two distinct actuation devices being constructed and arranged to transmit only a downshift control to the relay device.
